(19) United States
(12) Patent Application Publication
(10) Pub. No.: US 2015/0269152 A1
(43) Pub. Date: Sep. 24, 2015

(54) RECOMMENDATION RANKING BASED ON LOCATIONAL RELEVANCE

(71) Applicant: Microsoft Technology Licensing, LLC, Redmond, WA (US)

(72) Inventors: Karan Singh Rekhi, Bellevue, WA (US); Abhishek Jha, Bellevue, WA (US); Gautam Kedia, Bellevue, WA (US); Kieran Richard McDonald, Seattle, WA (US); Andrew P. McGovern, Seattle, WA (US)

(21) Appl. No.: 14/217,643

(22) Filed: Mar. 18, 2014

(51) Int. Cl. G06F 17/30

(52) U.S. Cl. CPC G06F 17/3053

(57) ABSTRACT

One or more techniques and/or systems are provided for ranking recommendations within a set of recommendations. For example, a set of locational relevance boundaries may be generated and/or configured for ranking the set of recommendation. For example, a locational relevance boundary may adjust a rank of a recommendation using a rank influence (e.g., a linear function, a step function, a numerical value, and/or any other function used to increase, decrease, or assign a value to the rank based upon a current location of the user). The locational relevance boundary may be applied based upon the current location of the user corresponding to one or more threshold distances from a target recommendation location. For example, a logarithmic function may be applied to a rank of a theater recommendation when the user is less than 1.2 miles from the theater. Ranked recommendations may be provided to the user.

### BACKGROUND

Many applications provide suggestive information to users, such as through a mobile device. For example, recommendations may be pushed to a cell phone based upon various contextual information of a user, such as a calendar, an email, a device location, user search history, etc. In an example, a map application may provide a restaurant recommendation to a user based upon a lunch entry within a calendar. In another example, a shopping application may provide merchandise recommendations to a user based upon prior shopping history and/or search history of the user. In this way, recommendations may be provided to a user based upon an inferred task intent and/or interest of the user.

### SUMMARY

This summary is provided to introduce a selection of concepts in a simplified form that are further described below in the detailed description. This summary is not intended to identify key factors or essential features of the claimed subject matter, nor is it intended to be used to limit the scope of the claimed subject matter.

Among other things, one or more systems and/or techniques for ranking recommendations within a set of recommendations is provided. In an example, a set of recommendations may be identified based upon a variety of contextual information about a user (e.g., social network information indicating an interest in seeing a movie, calendar information indicating a date night with a spouse, locational information indicating that the user is near a shopping district, user search history indicating that the user was researching movies and restaurants in the shopping district, etc.). Accordingly, it may be advantageous to rank the recommendations within the set of recommendations based upon locational information.

As provided herein, a set of locational relevance boundaries for ranking recommendations within the set of recommendations are generated. A locational relevance boundary may specify a rank influence (e.g., a numerical value, a linear function, a Gaussian function, a step function, a logarithmic function, a non-linear function, etc.) that is to be applied to a rank of a recommendation responsive to a current location of the user corresponding to an area defined by the locational relevance boundary (e.g. the current location being within a first threshold distance of a movie theater; the current location being at least a second threshold distance from the movie theater; the current user traveling towards the movie theater, traveling away from the movie theater, etc.). In an example, the set of locational relevance boundaries comprises a baseline locational relevance boundary having a baseline rank influence (e.g., a relatively low value, such as 10 out of 100). The baseline rank influence may be assigned to a recommendation based upon a current location of the user being at least a baseline threshold distance away from a target recommendation location of the recommendation (e.g., a relatively far away distance that indicates that the recommendation may have relatively low relevance to the user). In another example, the set of locational relevance boundaries comprises a static locational relevance boundary having a static rank influence (e.g., a relatively high value, such as 100 out of 100). The static rank influence may be assigned to the recommendation based upon the current location of the user being within a static threshold distance from the target recommendation location (e.g., a relatively close distance that indicates that the recommendation may have a relatively high relevance to the user).

In another example, the set of locational relevance boundaries comprises an increasing locational relevance boundary having an increasing rank influence. The increasing rank influence may increase the rank of the recommendation, such as according to a linear function or any other function, as the current location of the user moves from the baseline threshold distance towards the static threshold distance (e.g., the recommendation may become more relevant to the user as the user moves towards the target recommendation location). In another example, the set of locational relevance boundaries comprises a decreasing locational relevance boundary having a decreasing rank influence. The decreasing rank influence may decrease the rank of the recommendation, such as according to a linear function or any other function, as the current location of the user moves from the static threshold distance towards the baseline threshold distance (e.g., the recommendation may become less relevant to the user as the user moves away from the target recommendation location). In this way, recommendations within the set of recommendations may be ranked to create a ranked set of recommendations based upon the set of locational relevance boundaries and the current location of the user. In this way, at least some of the ranked set of recommendations may be provided to the user (e.g., displayed in an order from highest ranked to lowest ranked). The ranked set of recommendations may be dynamically re-ranked (e.g., in real-time during movement of the user and/or interaction by the user with a recommendation user interface), and provided to the user (e.g., a recommendation may be removed, added, or reordered).

To the accomplishment of the foregoing and related ends, the following description and annexed drawings set forth certain illustrative aspects and implementations. These are indicative of but a few of the various ways in which one or more aspects may be employed. Other aspects, advantages, and novel features of the disclosure will become apparent from the following detailed description when considered in conjunction with the annexed drawings.

### DESCRIPTION OF THE DRAWINGS

FIG. 1 is a flow diagram illustrating an exemplary method of ranking recommendations within a set of recommendations.

FIG. 2 is a component block diagram illustrating an exemplary system for ranking recommendations within a set of recommendations.

FIG. 3A is an illustration of an example of ranking a recommendation based upon a first current user location.

FIG. 3B is an illustration of an example of ranking a recommendation based upon a second current user location.

FIG. 3C is an illustration of an example of ranking a recommendation based upon a third current user location.

FIG. 3D is an illustration of an example of ranking a recommendation based upon a fourth current user location.

FIG. 3E is an illustration of an example of ranking a recommendation based upon a fifth current user location.

FIG. 3F is an illustration of an example of ranking a recommendation based upon a sixth current user location.

FIG. 3G is an illustration of an example of ranking a recommendation based upon a seventh current user location.

FIG. 3H is an illustration of an example of ranking a recommendation based upon an eighth current user location.

FIG. 3I is an illustration of an example of ranking a recommendation based upon a ninth current user location.

FIG. 4A is an illustration of an example of ranking a set of recommendations based upon a first current user location.

FIG. 4B is an illustration of an example of ranking a set of recommendations based upon a second current user location.

FIG. 4C is an illustration of an example of ranking a set of recommendations based upon a third current user location.

FIG. 5 is an illustration of an exemplary computer readable medium wherein processor-executable instructions configured to embody one or more of the provisions set forth herein may be comprised.

FIG. 6 illustrates an exemplary computing environment wherein one or more of the provisions set forth herein may be implemented.

### DETAILED DESCRIPTION

The claimed subject matter is now described with reference to the drawings, wherein like reference numerals are generally used to refer to like elements throughout. In the following description, for purposes of explanation, numerous specific details are set forth to provide an understanding of the claimed subject matter. It may be evident, however, that the claimed subject matter may be practiced without these specific details. In other instances, structures and devices are illustrated in block diagram form in order to facilitate describing the claimed subject matter.

One or more techniques and/or systems for ranking recommendations within a set of recommendations are provided. For example, a set of recommendations for restaurants and theaters may be identified based upon social network information of a user indicating that the user is going on a date. As provided herein, recommendations within the set of recommendations may be ranked based upon various locational relevance boundaries (e.g., user specified locational relevance boundaries, adjustable/modifiable locational relevance boundaries, automatically generated locational relevance boundaries, etc.). For example, a set of locational relevance boundaries may comprise locational relevance boundaries that define rank influences (e.g., a relative low baseline rank value assigned to recommendations that may be less relevant to the user; a relatively higher static rank value assigned to recommendations that may be more relevant to the user; an increasing rank value as the user approaches a target recommendation location; a decreasing rank value as the user moves away from a target recommendation location; etc.) that may be applied to ranks of recommendations based upon a current location of the user. Rank influence values and/or threshold distances may be configurable. In an example, a restaurant type recommendation may have a static threshold distance of 0 to 0.5 miles from a restaurant, a baseline threshold distance greater than 3 miles from the restaurant, and increase/decreasing rank thresholds between 0.5 miles and 3 miles that utilize a step function. In another example, a movie type recommendation may have a static threshold distance of 0 to 0.2 miles from a theater, a baseline threshold distance greater than 6 miles from the theater, and increase/decreasing rank thresholds between 0.2 miles and 6 miles that utilize a linear function. In this way, one or more ranked recommendations may be provided to the user.

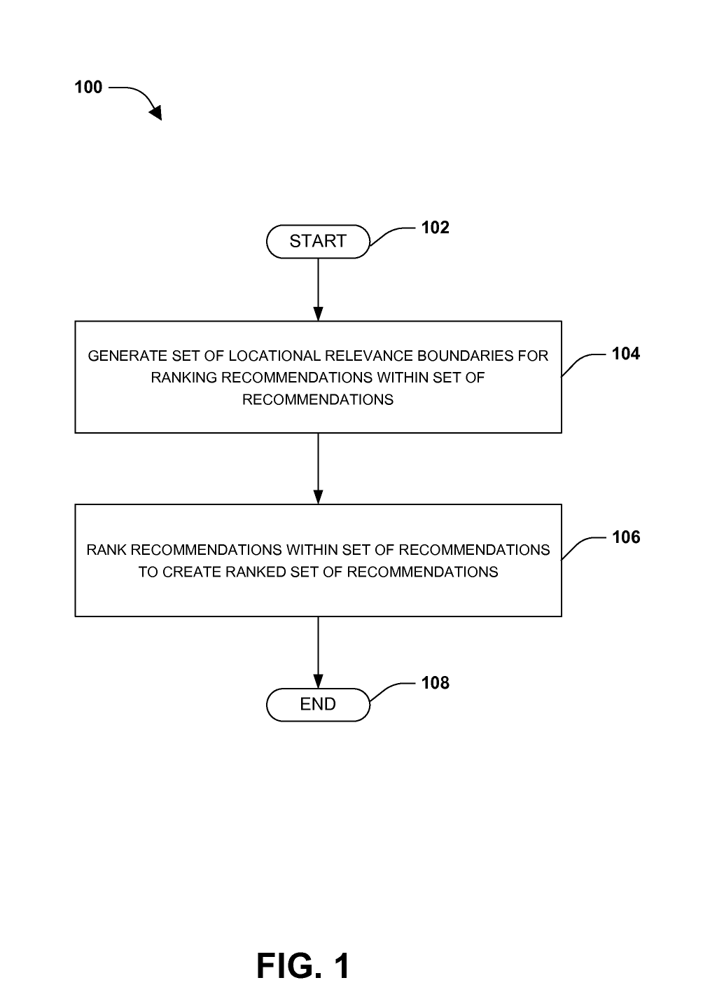

An embodiment of ranking recommendations within a set of recommendations is illustrated by an exemplary method 100 of FIG. 1. At 102, the method starts. In an example, client-side ranking of recommendations may be performed on a client device (e.g., a recommendation ranking component, hosted on the client device, may be configured to rank recommendations that are to be displayed through the client device). Client-side ranking may improve security of client-side information such as user data that may be used for ranking and/or may improve performance of dynamically re-ranking recommendations in real-time such as while recommendations are displayed through the client device. In another example, server-side ranking of recommendations may be performed, and the ranked recommendations may be provided to a client device for display to a user (e.g., a recommendation ranking component, hosted on a server, may rank recommendations that are to be provided to a client device such as a mobile device).

In an example, a set of recommendations may be identified. For example, the set of recommendation may comprise an electronics store, a videogame store, a shopping mall, a coffee shop, a candy shop, and/or other stores or locations identified based upon a user intent to holiday shop (e.g., a social network profile, an email, browsing history, and/or other information may be evaluated to identify a holiday shopping activity). The recommendations within the set of recommendations may be ranked so that recommendations may be provided and/or displayed according to such ranks (e.g., relatively higher ranked recommendations may be displayed more prominently, such as above or earlier, than relatively lower ranked recommendations because relatively higher ranked recommendations may be more relevant to the user).

At 104, a set of locational relevance boundaries for ranking recommendations within the set of recommendations is generated. A locational relevance boundary may be used to increase, decrease, and/or assign values to a rank of a recommendation using a function (e.g., a numerical value, a linear function, a Gaussian function, a step function, a logarithmic function, a non-linear function, etc.) responsive to a current location of a user (e.g., a GPS location of a mobile device, such as a cell phone, a tablet, a vehicle device, etc.) being within a threshold distance from a target recommendation location (e.g., an area defined by a 0.5 to 3 mile radius from the target recommendation location).

In an example, the set of locational relevance boundaries comprises a baseline locational relevance boundary having a baseline rank influence (e.g., a relatively low value, such as 5 out of 100, which may indicate that the recommendation may have relatively low relevance to the user). The baseline locational relevance boundary may be located at least a baseline threshold distance away from the target recommendation location (e.g., an area that is 6 miles or further away from the target recommendation location). In another example, the set of locational relevance boundaries comprises a static locational relevance boundary having a static rank influence (e.g., a relatively high value, such as 100 out of 100, which may indicate that the recommendation may have relatively high relevance to the user). The static locational relevance boundary may be located a static threshold distance from the target recommendation location (e.g., 1 mile or less from the target recommendation location).

In another example, the set of locational relevance boundaries comprises an increasing locational relevance boundary having an increasing rank influence (e.g., a linear function specifying that the rank is to increase by 3 points for each 0.1 mile traveled by the user closer to the target recommendation location). The increasing locational relevance boundary may correspond to a first change in current location of the user from the baseline threshold distance towards the static threshold distance (e.g., movement within an area between the 6 mile baseline threshold and the 1 mile static threshold distance, which is towards the static threshold distance such as towards the target recommendation location). In another example, the set of locational relevance boundaries comprises a decreasing locational relevance boundary having a decreasing rank influence (e.g., a linear function specifying that the rank is to decrease by 7 points for each 0.2 miles traveled by the user away from the target recommendation location). The decreasing locational relevance boundary may correspond to a second change in current location of the user from the static threshold distance towards the baseline threshold distance (e.g., movement within an area between the 6 mile baseline threshold and the 1 mile static threshold distance, which is away from the static threshold distance such as away from the target recommendation location).

It may be appreciated that a variety of other locational relevance boundaries may be created and/or customized. In an example, a user configured locational relevance boundary having a user configured rank influence may be generated for inclusion within the set of locational relevance boundaries. The user configured locational relevance boundary may correspond to one or more threshold distances from the target recommendation location. For example, the user may specify (e.g., through a recommendation configuration interface) that ranks of shopping malls are to be increased by a step function when the user is traveling by car towards a shopping mall while being within radius between 5 miles away and 15 miles away from the shopping mall. In another example, a hidden relevance boundary having a hidden rank influence may be generated for inclusion within the set of locational relevance boundaries (e.g., the hidden relevance boundary may be automatically generated or specified by the user). The hidden locational relevance boundary corresponds to a hidden threshold distance from the target recommendation location (e.g., a recommendation may be hidden from the user when the user is further than 20 miles from the target recommendation location).

Various aspects of locational relevance boundaries may be configurable. For example, threshold distances (e.g., the static threshold distance may be changed form 1 mile to 0.8 miles), rank values (e.g., the baseline rank may be changed from 5 miles to 3 miles), rank adjustment functions (e.g., a linear function may be changed to a logarithmic decay function), an applicable recommendation type, (e.g., the user configured locational relevance boundary may be changed to also apply to parks), and/or other information may be configurable. In an example, the baseline threshold distance, the static threshold distance, and/or other threshold distances may be configured based upon user specific criteria (e.g., a user may specify the new 0.8 miles threshold for the static threshold distance). In another example, the baseline threshold distance, the static threshold distance, and/or other threshold distances may be configured based upon a transportation mode (e.g., car, boat, bicycle, walking, etc.), a time of day (e.g., the static threshold distance may be decreased to 0.4 miles based upon an hours of operation for a store recommendation indicating that the store is about to close), weather (e.g., threshold distances for an ice cream shop may be decreased during winter due to a seasonal decrease in user interest), a date (e.g., threshold distances for sports bars may be increased during sporting events), etc.

In another example, the baseline threshold distance, the static threshold distance, and/or other threshold distances may be configured based upon a historical user interaction pattern associated with the user (e.g., the user may typically browse movie recommendations when the user is about 5 miles away from a theater, and the user may actively interact with movie recommendations when the user is about 0.6 miles away from the theater, and thus the baseline threshold distance may be set to 5 miles and the static threshold distance may be set to 0.6 miles). In another example, the baseline threshold distance, the static threshold distance, and/or other threshold distances may be configured based upon a machine learned boundary (e.g., users typically browse work travel traffic recommendations while still at home, and thus an alert threshold distance for an alert locational relevance boundary may be set to a distance between the user's home and work such that an alert may be provided for a work travel traffic recommendation when the user is within the alert threshold distance from work and a current time is 3 hours or less before the start of the user's work day).

In another example, locational relevance boundaries and/or threshold distances may be personalized for different users based on user specific signals, such as travel speed, travel mode, etc. of a user (e.g., walking, running, cycling, driving, bus, etc.). For example, because a user is able to traverse a given distance more quickly when traveling by car as opposed to walking, a threshold distance may be increased when the user is travelling by car as compared to when the user is walking, for example.

In another example, time context may be used to tune locational relevance boundaries and/or threshold distances (e.g., users may typically travel farther for a restaurant during dinner time as compared to during work hours, and thus a threshold distance may be increased during dinner time as compare to during work hours).

In another example, the baseline threshold distance, the static threshold distance, and/or other threshold distances may be configured based upon a recommendation type of the recommendation (e.g., the baseline threshold distance may be set to 30 miles for an airport, while the baseline threshold distance may be set to 1 mile for an ice cream shop). In another example, at least some of the ranked set of recommendation may be provided to the user during a recommendation session (e.g., corresponding to a session during which recommendations are made available, such as displayed, to the user). During the recommendation session, the baseline threshold, the static threshold, and/or other thresholds may be dynamically modified (e.g., one or more thresholds for a movie theater may be decreased as a closing time of the movie theater approaches). In this way, a wide variety of locational relevance boundaries may be created (e.g., user specified or automatically) and/or configured.

At 106, recommendations within the set of recommendations are ranked to create a ranked set of recommendations (e.g., recommendations may be ordered for display to a user based upon such ranks) based upon the set of locational relevance boundaries, a current location of the user, and/or other contextual information (e.g., a current time, traffic conditions, a time until a flight is to board or depart, an amount of change in a stock price, a news story indicating a store sale or store closing, a transportation mode of the user, etc.). In an example, the baseline rank influence may be assigned to a rank of a recommendation within the set of recommendations such that the rank corresponds to a baseline rank (e.g., based upon a current location of the user indicating that the user is at least the baseline threshold distance from a target recommendation location). In another example, the static rank influence may be assigned to the rank of the recommendation such that the rank corresponds to a static rank (e.g., based upon a current location of the user indicating that the user is the static threshold distance or closer to the target recommendation location). In another example, the increasing rank influence is applied to the rank to increase the rank (e.g., based upon a linear function, a non-linear function, a user specified numerical value, a logarithmic function, etc.). In another example, the decreasing rank influence is applied to the rank to decrease the rank (e.g., based upon a linear function, a non-linear function, a user specified numerical value, a logarithmic function, etc.).

Different rank influences may be applied to adjust the rank of the recommendation based upon changes in the current location of the user. In an example, responsive to determining that a first current location of the user corresponds to the baseline locational relevance boundary, the baseline rank influence may be applied to the rank of the recommendation. Responsive to determining that a second current location of the user corresponds to the increasing locational relevance boundary, the increasing rank influence may be applied to the rank of the recommendation. In another example, responsive to determining that the first current location of the user corresponds to the increasing locational relevance boundary, the increasing rank influence may be applied to the rank of the recommendation. Responsive to determining that the second current location of the user corresponds to the static locational relevance boundary, the static rank influence may be applied to the rank of the recommendation. In another example, responsive to determining that the first current location of the user corresponds to the static locational relevance boundary, the static rank influence may be applied to the rank of the recommendation. Responsive to determining that the second current location of the user corresponds to the decreasing locational relevance boundary, the decreasing rank influence may be applied to the rank of the recommendation.

At least some of the ranked set of recommendations may be provided to the user, such as during a recommendation session (e.g., one or more recommendations may be displayed through a client device, such as through an app, a recommendation user interface, a notification, an operating system interface such as a homepage or a search charm, a website such as a search engine homepage or social network, etc.). Recommendations may be provided based upon ranks assigned to such recommendations (e.g., relatively higher ranked recommendations may be displayed more prominently than relatively lower ranked recommendations; a recommendation may be visually modified based upon a rank such as highlighted, grayed out, or displayed with an advertisement; a relatively low ranked recommendation may be hidden; etc.). For example, a recommendation may be provided based upon a rank of the recommendation exceeding a rank threshold.

In an example, the ranked set of recommendations may be re-ranked during the recommendation session to create a dynamically re-ranked set of recommendations based upon an updated current location of the user (e.g., the user may transition into the static threshold distance from the target recommendation location). At least some of the dynamically re-ranked set of recommendations may be provided to the user during the recommendation session (e.g., a new recommendation may be displayed, a recommendation may be hidden, a recommendation may be reordered, etc.). In an example, responsive to determining that a current location of the user corresponds to a target recommendation threshold, the recommendation may be hidden based upon the recommendation having a first recommendation type (e.g., a work traffic route recommendation, having a work or driving recommendation type, may be hidden when the user reaches work). In another example, responsive to determining that a current location of the user corresponds to a target recommendation threshold, the recommendation may be populated with additional information based upon the recommendation having a second recommendation type (e.g., a movie theater recommendation, having a movie recommendation type, may be populated with movie listing information, online ticket purchasing functionality, movie trailers, advertisements, user reviews, or other information as the user arrives at the movie theater). In this way, recommendations may be ranked, re-ranked, and/or provided to a user. At 108, the method ends.

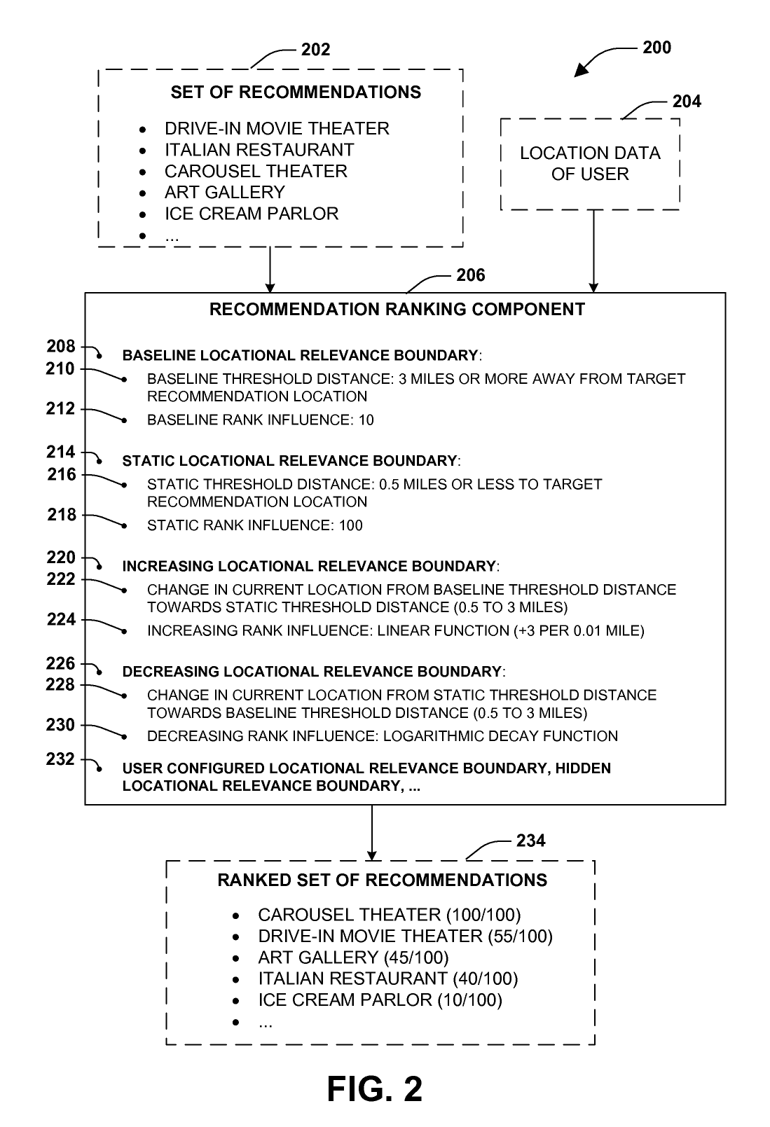

FIG. 2 illustrates an example of a system 200 for ranking a set of recommendations 202. The system 200 comprises a recommendation ranking component 206 configured to rank the set of recommendations 202 based upon various information, such as location data 204 of a user. In an example, the set of recommendations 202 may comprise a drive-in movie theater recommendation, an Italian restaurant recommendation, a carousel theater recommendation, an art gallery recommendation, an ice cream parlor recommendation, and/or other recommendations corresponding to a date night intent identified for the user.

The recommendation ranking component 206 may rank the set of recommendations using a set of locational relevance boundaries to create a ranked set of recommendations 234. In an example, a baseline locational relevance boundary 208 may specify that a baseline rank influence 212 of 10 is to be applied to a rank of a recommendation based upon the location data 204 indicating that a current location of the user is at least a baseline threshold distance 210 from a target recommendation location (e.g., the rank may be set to 10 based upon the user being 3 miles or more away from the target recommendation location). A static locational relevance boundary 214 may specify that a static rank influence 218 of 100 is to be applied to a rank of a recommendation based upon the location data 204 indicating that a current location of the user is within a static threshold distance 218 from a target recommendation location (e.g., the rank may be set to 100 based upon the user being 0.5 miles or less from the target recommendation location).

An increasing locational relevance boundary 220 may specify that an increasing rank influence 224 is to be applied to a rank of a recommendation based upon the location data 204 indicating that a first change in location of the user indicates that the user is traveling 222 from the baseline threshold distance towards the static threshold distance (e.g., the rank may be increased by 3 for every 0.01 miles that the user travels from the baseline threshold distance towards the target recommendation location). A decreasing locational relevance boundary 226 may specify that a decreasing rank influence 230 is to be applied to a rank of a recommendation based upon the location data 204 indicating that a second change in location of the user indicates that the user is traveling 228 from the static threshold distance towards the baseline threshold distance (e.g., the rank may be decreased based upon a logarithmic decay function because the user is traveling away from the target recommendation location). Other locational relevance boundaries, such as a user configured locational relevance boundary, a hidden locational relevance boundary, a machine learned locational relevance boundary, etc., may be used to rank the set of recommendations.

In this way, the recommendation ranking component 206 may utilize the set of locational relevance boundaries to rank recommendations within the set of recommendations 202 to create the ranked set of recommendations 234. For example, a rank for the carousel theater recommendation may be assigned to the static influence rank 218 of 100 because the user may be within the static threshold distance 216 from the carousel theater. A rank for the ice cream parlor may be assigned to the baseline rank influence 212 of 10 because the user may be at least the baseline threshold distance 210 from the ice cream parlor. Similarly, the increasing locational relevance boundary, the decreasing locational relevance boundary, and/or other locational relevance boundaries may be used to rank the drive-in movie theater recommendation, the art gallery recommendation, the Italian restaurant recommendation, and/or other recommendations. At least some of the ranked set of recommendations 234 may be provided to the user.

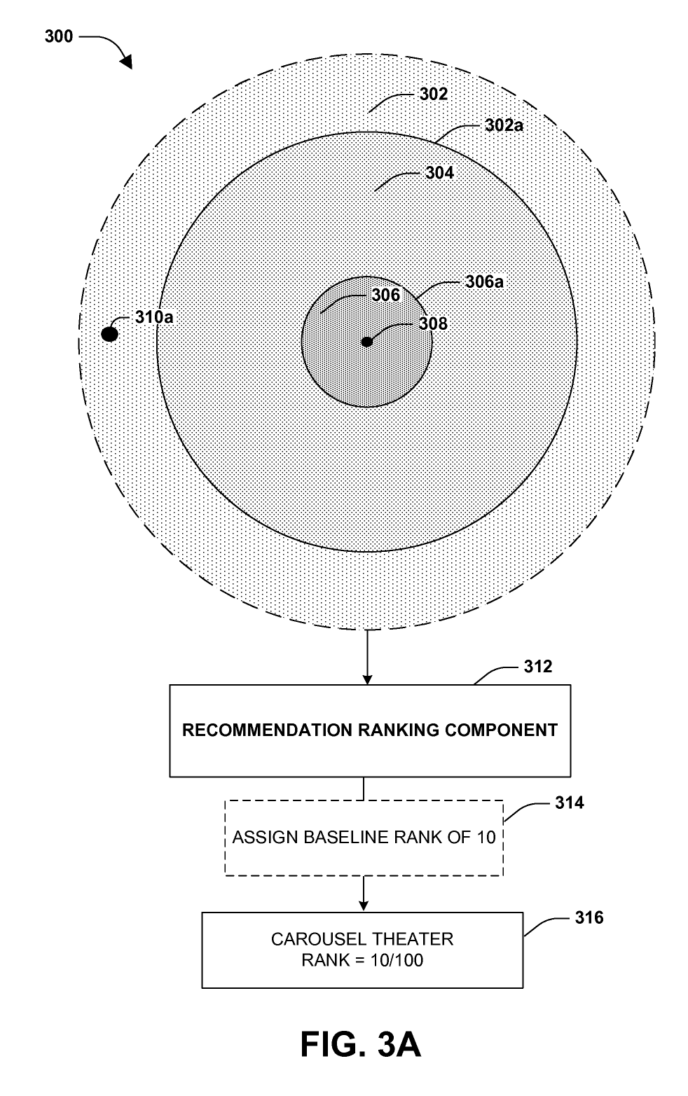

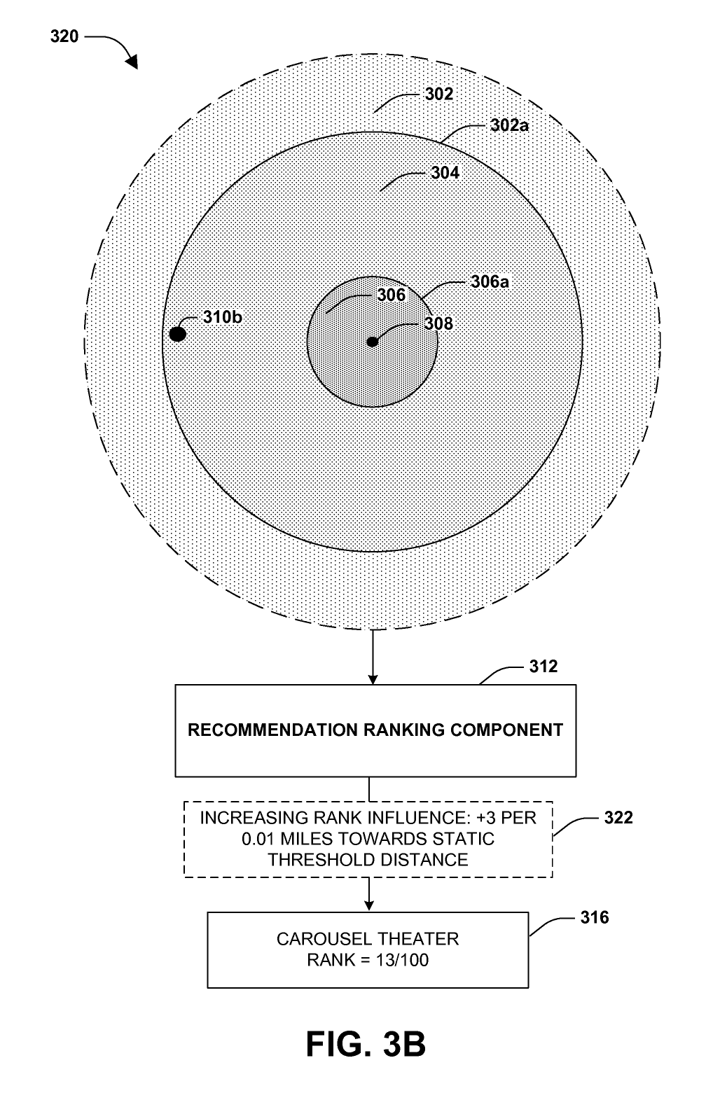

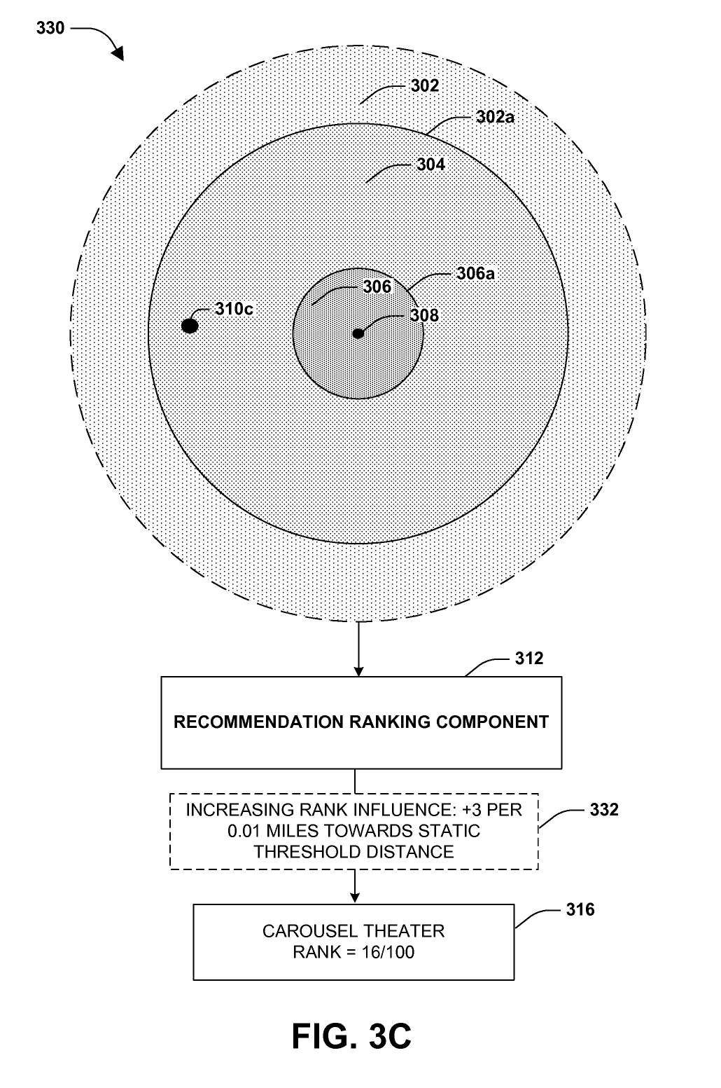

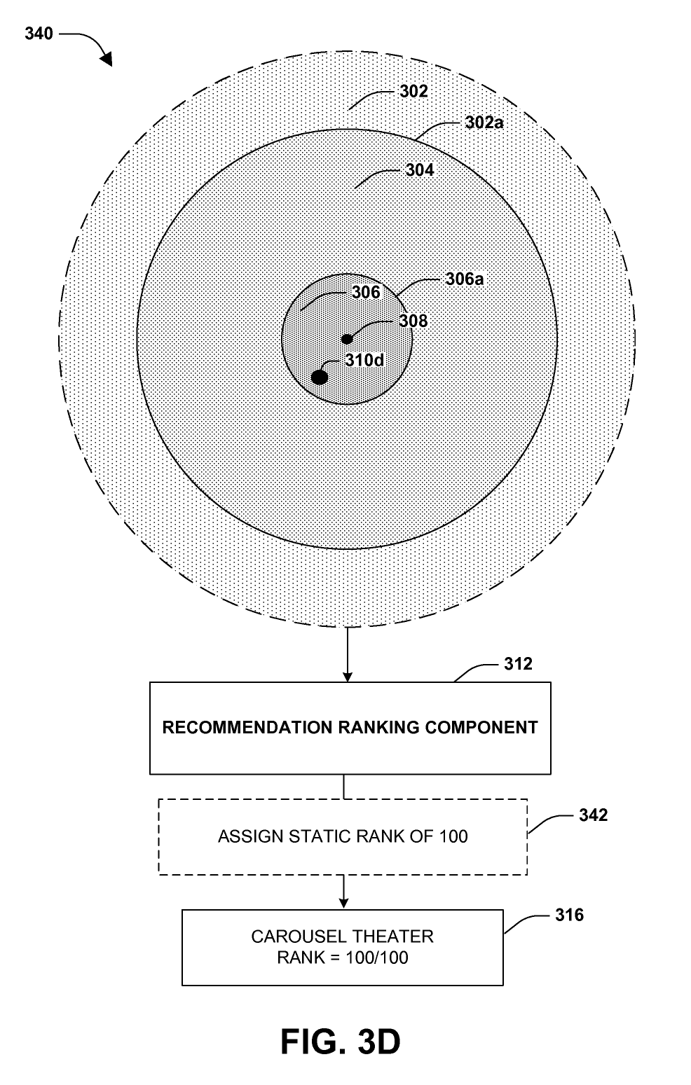

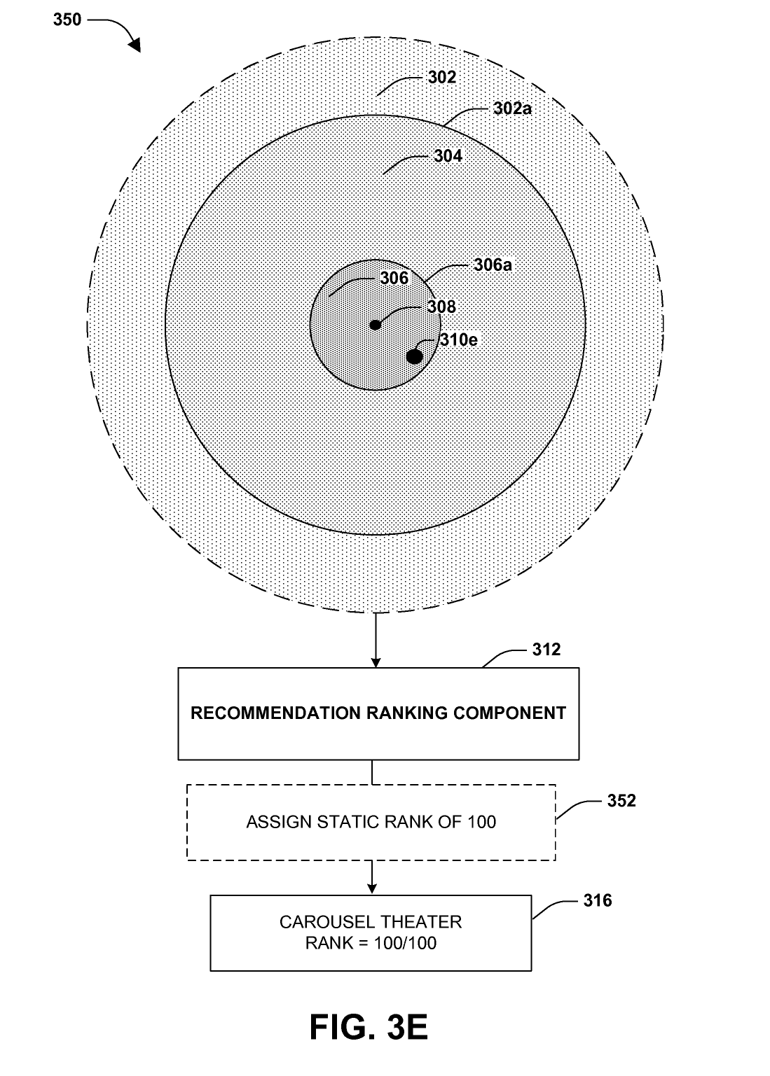

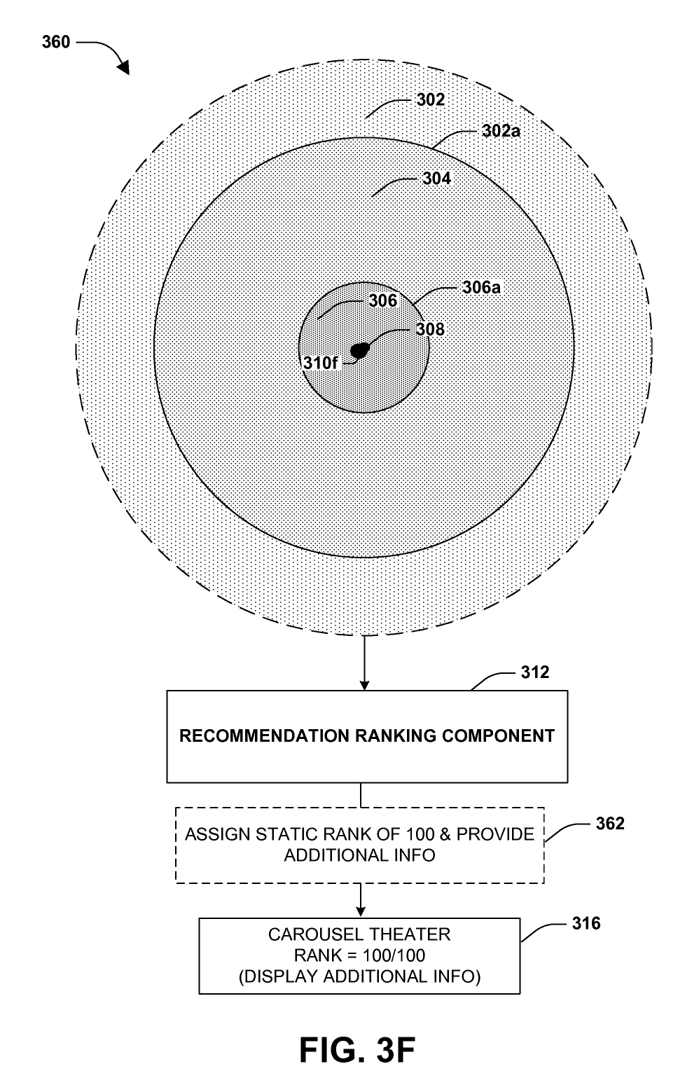

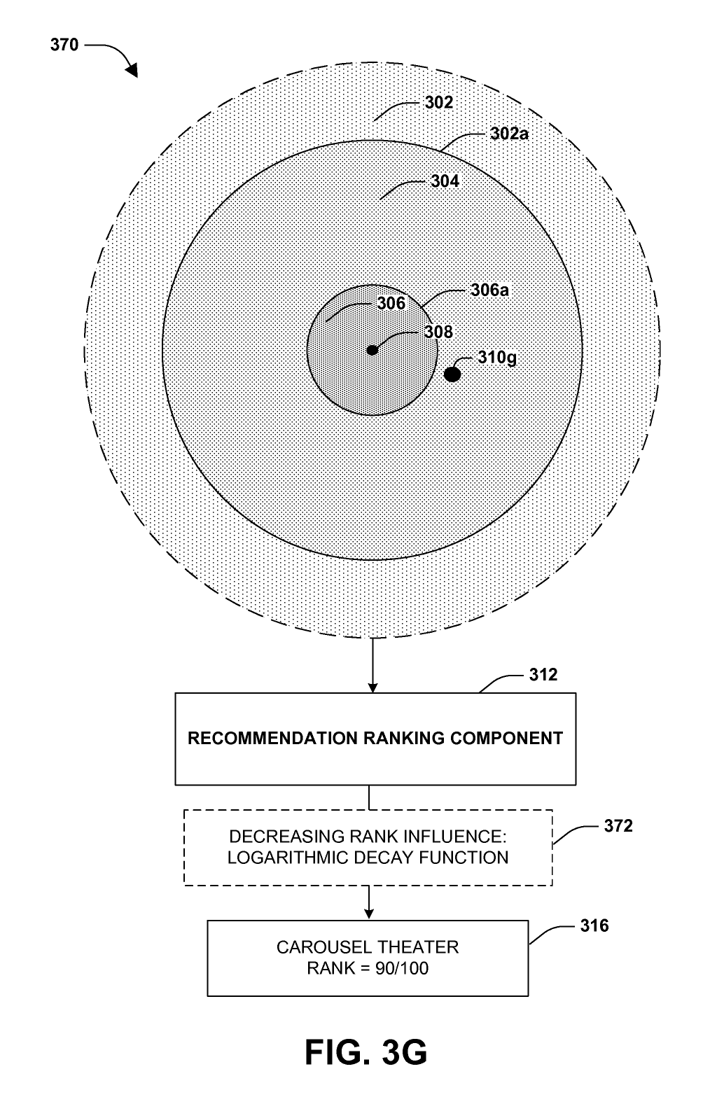

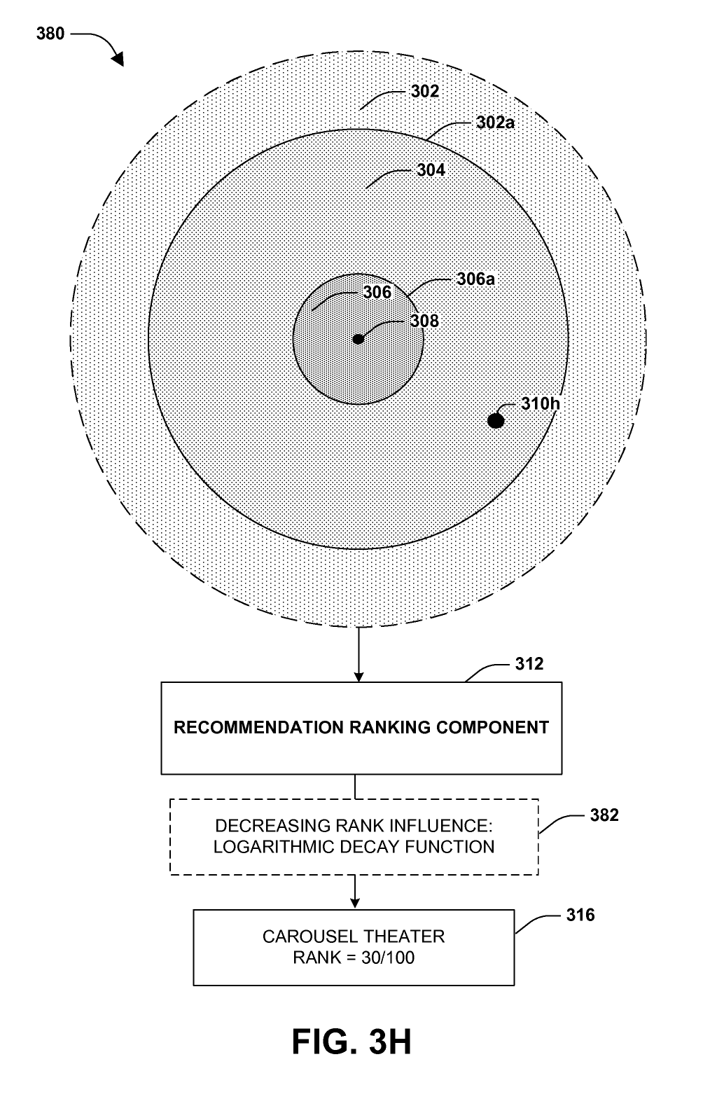

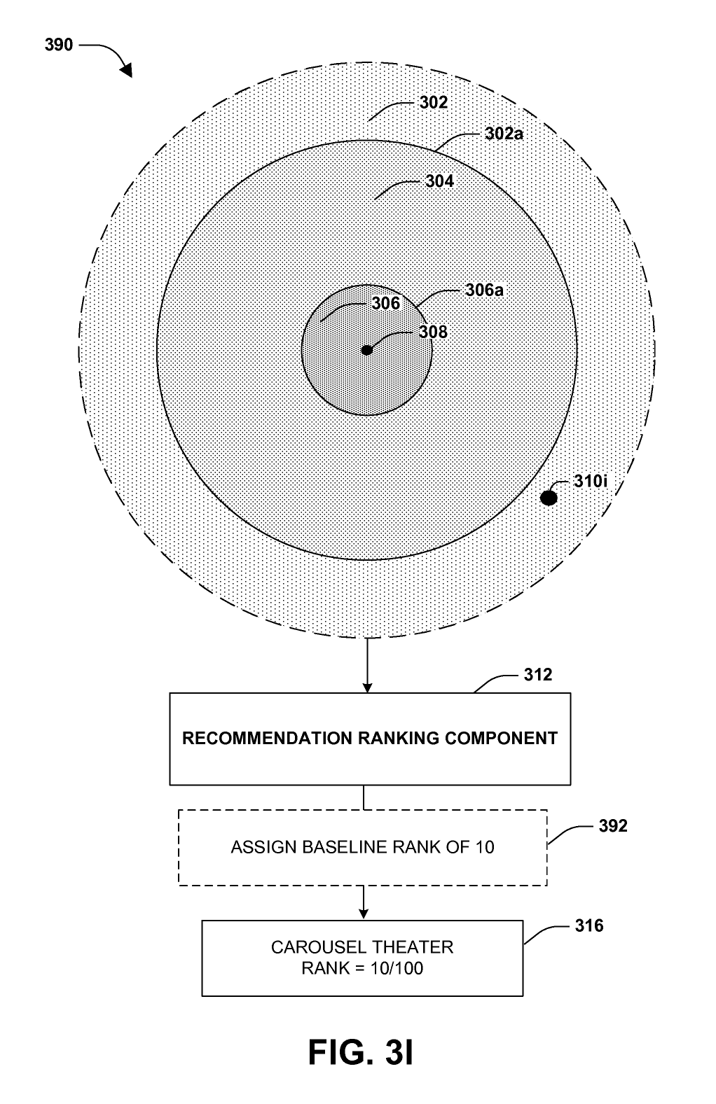

FIGS. 3A-3I illustrate examples of ranking a carousel theater recommendation 316 based upon changes in a current location of a user. A recommendation ranking component 312 may be configured to rank the carousel theater recommendation 316 based upon a baseline locational relevance boundary associated with a baseline area 302, a static locational relevance boundary associated with a static area 306, an increasing locational relevance boundary associated with a transitional area 304, a decreasing locational relevance boundary associated with the transitional area 304, and/or other locational relevance boundaries associated with a target recommendation location 308 (e.g., a location, such as longitude/latitude coordinates, of a carousel theater building). In an example, the recommendation ranking component 312 may assign 314 a baseline influence rank of 10 to the carousel theater recommendation 316 based upon a first current location 310a of the user being at least a baseline threshold distance 302a away from the target recommendation location 308 (e.g., within the baseline area 302), as illustrated by example 300 of FIG. 3A.

In an example, the recommendation ranking component 312 may assign 322 an increasing influence rank to the carousel theater recommendation 316 (e.g., the rank may be increased by 3 from 10 to 13) based upon a second user location 310b indicating that the user traveled 0.01 miles from the baseline threshold distance 302a towards a static threshold distance 306a (e.g., within the transitional area 304), as illustrated by example 320 of FIG. 3B. In an example, the recommendation ranking component 312 may assign 332 an increasing influence rank to the carousel theater recommendation 316 (e.g., the rank may be increased by 3 from 13 to 16) based upon a third user location 310c indicating that the user traveled an additional 0.01 miles from the baseline threshold distance 302a towards the static threshold distance 306a (e.g., within the transitional area 304), as illustrated by example 330 of FIG. 3C.

In an example, the recommendation ranking component 312 may assign 342 a static influence rank of 100 to the carousel theater recommendation 316 based upon a fourth current user location 310d of the user being within the static threshold distance 306a from the target recommendation location 308 (e.g., within the static area 306), as illustrated by example 340 of FIG. 3D. In an example, the recommendation ranking component 312 may continue to assign 352 the static rank to the carousel theater recommendation 316 while the user is within the static threshold distance 306a from the target recommendation location 308 (e.g., a fifth current user location 310e within the static area 306), as illustrated by example 350 of FIG. 3E. In an example, the recommendation ranking component 312 may continue to assign 362 the static rank to the carousel theater recommendation 316 and may display additional information (e.g., a ticket purchasing interface, user reviews, show times, coupons, etc.) for the carousel theater recommendation 316 based upon the user arriving at the target recommendation location 308 (e.g., a sixth current user location 310f indicating that the user arrived at the carousel theater building), as illustrated in example 360 of FIG. 3F.

In an example, the recommendation ranking component 312 may assign 372 a decreasing influence rank to the carousel theater recommendation 316 (e.g., the rank may be decreased from 100 to 90 based upon a logarithmic decay function) based upon a seventh user location 310g indicating that the user traveled from the static threshold distance 306a towards the baseline threshold distance 302a (e.g., within the transitional area 304), as illustrated by example 370 of FIG. 3G. In an example, the recommendation ranking component 312 may continue to assign 382 the decreasing influence rank to the carousel theater recommendation 316 (e.g., the rank may be decreased from 90 to 30 based upon the logarithmic decay function) based upon an eighth user location 310h indicating that the user continued traveling from the static threshold distance 306a towards the baseline threshold distance 302a (e.g., within the transitional area 304), as illustrated by example 380 of FIG. 3H.

In an example, the recommendation ranking component 312 may assign 392 the baseline influence rank of 10 to the carousel theater recommendation 316 based upon a ninth current location 310i of the user being at least the baseline threshold distance 302a away from the target recommendation location 308 (e.g., within the baseline area 302), as illustrated by example 390 of FIG. 31. In this way, the carousel theater recommendation 316 may be ranked and/or provided to the user in real-time (e.g., during a recommendation session where the user is traveling).

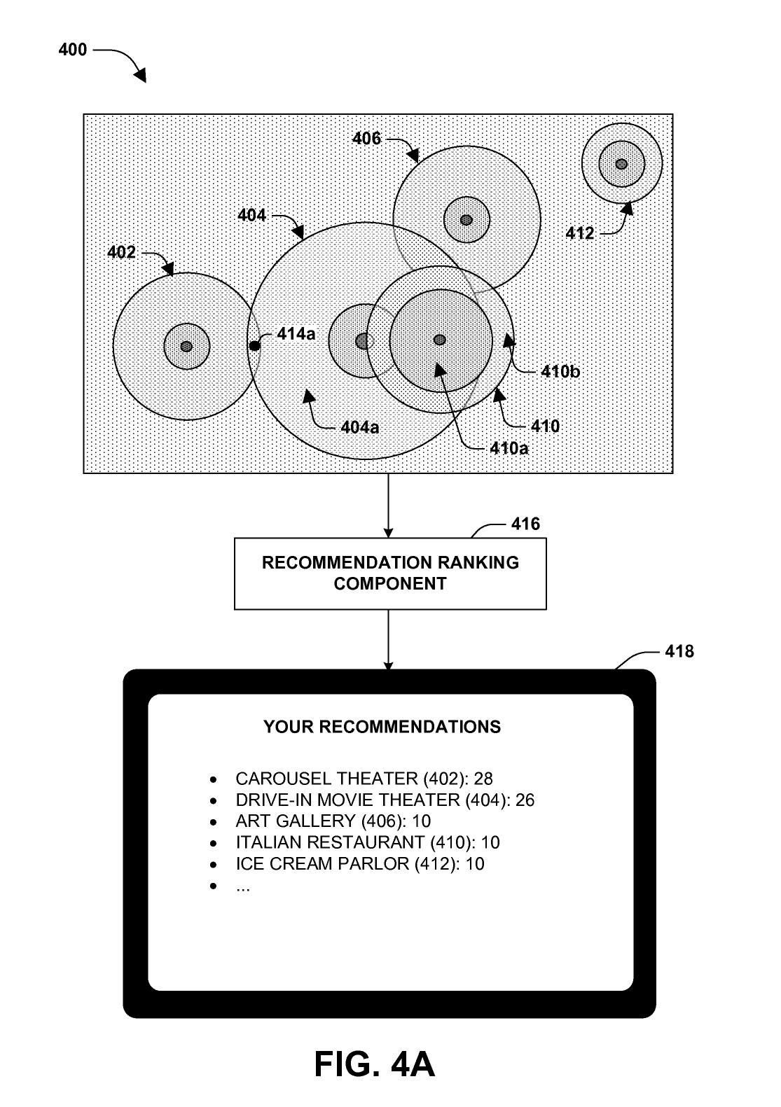

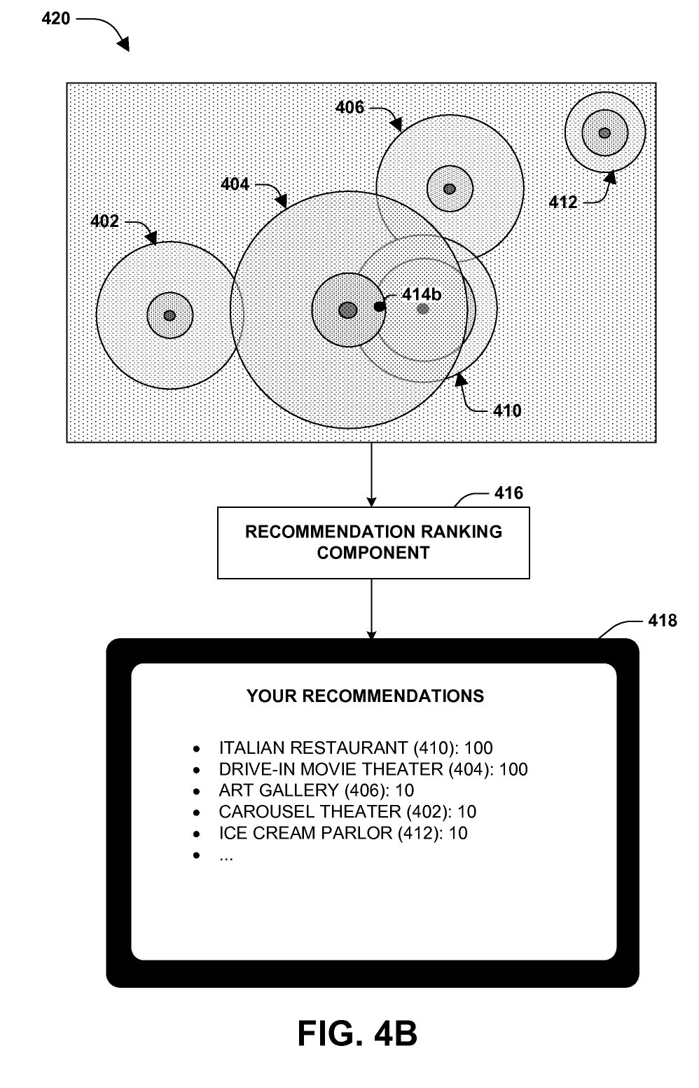

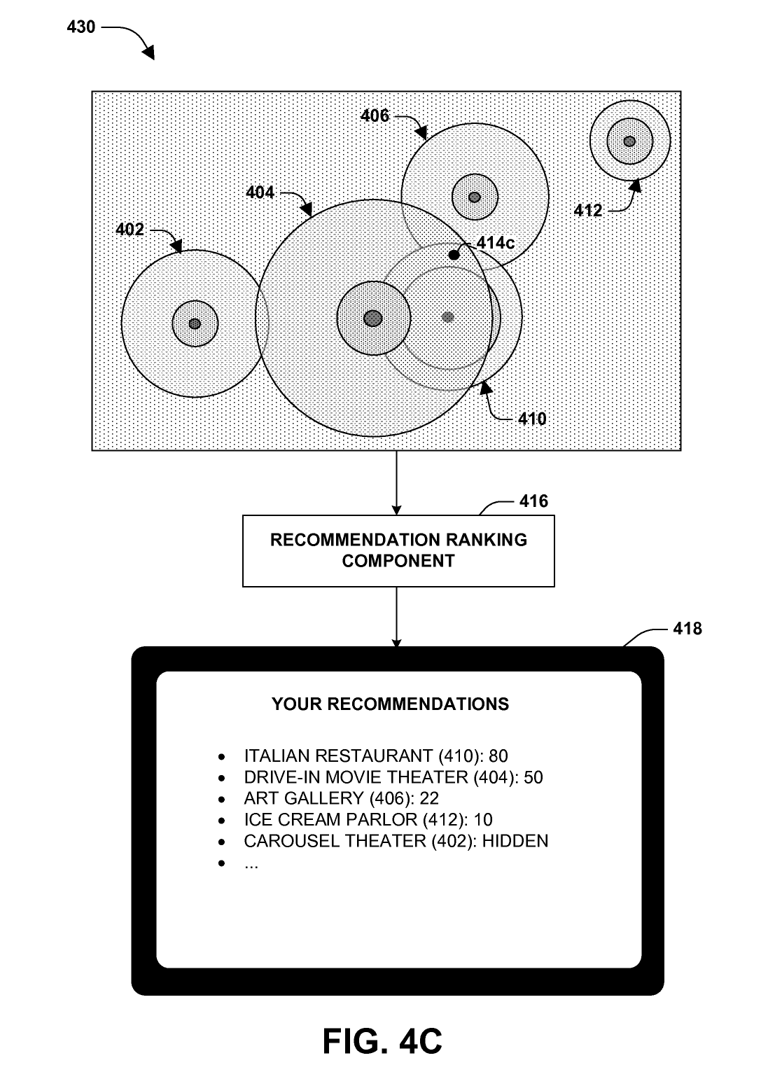

FIGS. 4A-4C illustrate examples of ranking a set of recommendations, provided through a client device 418, based upon changes in a current location of a user. A recommendation ranking component 416 may be configured to rank recommendations within the set of recommendations based upon a set of locational relevance boundaries. Locational relevance boundaries may be configured for various types of recommendations, as illustrated by example 400 of FIG. 4A. In an example, an ice cream parlor recommendation 412 may have one or more relatively smaller threshold distances that are configured based upon an ice cream recommendation type where users generally browse ice cream recommendations when they are relatively close to an ice cream shop. In another example, a drive-in movie theater recommendation 404 may have a relatively larger baseline threshold distance 404a that is configured based upon a movie recommendation type where users generally browse movie recommendations when they are relatively further away from a movie theater such as while at home. In another example, an Italian restaurant recommendation 410 may have a relatively larger static threshold distance 410a and a relatively smaller baseline threshold distance 410b based upon a restaurant recommendation type where users may express relatively strong interest in restaurant recommendations while they are within the static threshold distance 410a from a restaurant. In this way, the set of locational relevance boundaries may be used to rank a carousel theater recommendation 402, the drive-in movie theater recommendation 404, an art gallery recommendation 406, the Italian restaurant recommendation 410, the ice cream parlor recommendation 412, and/or other recommendations for display through the client device 418.

In an example, the recommendation ranking component 416 may assign a rank of 28 to the carousel theater recommendation 402 and a rank of 26 to the drive-in movie theater recommendation 404 based upon a first current location 414a of the user being between static threshold distances and baseline threshold distances of the carousel theater recommendation 402 and the drive-in movie theater 404, as illustrated by example 400 of FIG. 4A. The recommendation ranking component 416 may assign a baseline influence rank of 10 to the art gallery recommendation 406, the Italian restaurant recommendation 410, and the ice cream parlor recommendation 412 based upon the first current location 414a of the user being at least a baseline threshold distance away from such target recommendation locations. In this way, at least some of the ranked recommendation may be displayed through the client device 418.

In an example, the recommendation ranking component 416 may assign a static influence rank of 100 to the drive-in movie theater recommendation 404 and the Italian restaurant 410 based upon a second current location 414b of the user being a static threshold distance or less away from such target recommendation locations, as illustrated by example 420 of FIG. 4B. The recommendation ranking component 416 may assign the baseline influence rank of 10 to the carousel theater recommendation 402 based upon the second current location 414b of the user being at least a baseline threshold distance away from a target recommendation location of the carousel theater recommendation 402. In this way, at least some of the re-ranked recommendations may be displayed through the client device 418.

In an example, the recommendation ranking component 416 may assign a rank of 80 to the Italian restaurant recommendation 410, a rank of 50 to the drive-in movie theater recommendation 404, and a rank of 22 to the art gallery recommendation 406 based upon a third current location 414c of the user being between static threshold distances and baseline threshold distances of Italian restaurant recommendation 410, the drive-in movie theater recommendation 404, and the art gallery recommendation 406, as illustrated by example 430 of FIG. 4C. The recommendation ranking component 416 may assign a hidden influence rank of “hidden” to the carousel theater recommendation 402 (e.g., the carousel theater recommendation 402 may be hidden from display through the client device 418) based upon the third current location 414c of the user being at least a hidden threshold distance away from a target recommendation location of the carousel theater recommendation 402. In this way, at least some of the re-ranked recommendation may be displayed through the client device 418.

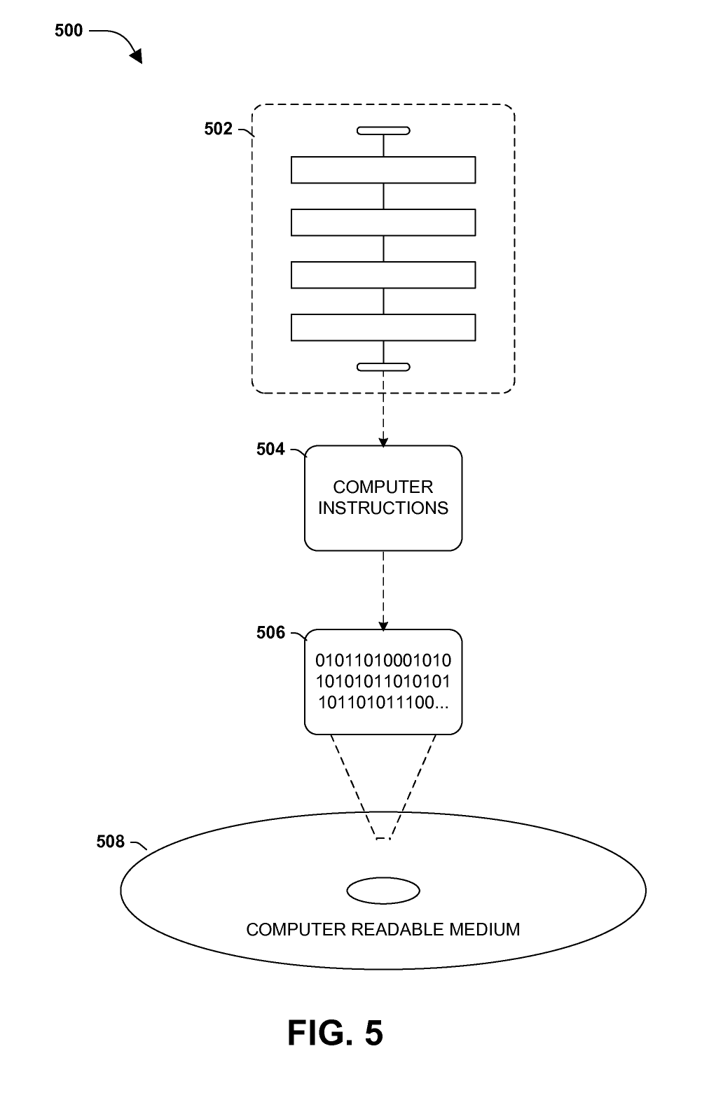

Still another embodiment involves a computer-readable medium comprising processor-executable instructions configured to implement one or more of the techniques presented herein. An example embodiment of a computer-readable medium or a computer-readable device is illustrated in FIG. 5, wherein the implementation 500 comprises a computer-readable medium 508, such as a CD-R, DVD-R, flash drive, a platter of a hard disk drive, etc., on which is encoded computer-readable data 506. This computer-readable data 506, such as binary data comprising at least one of a zero or a one, in turn comprises a set of computer instructions 504 configured to operate according to one or more of the principles set forth herein. In some embodiments, the processor-executable computer instructions 504 are configured to perform a method 502, such as at least some of the exemplary method 100 of FIG. 1, for example. In some embodiments, the processor-executable instructions 504 are configured to implement a system, such as at least some of the exemplary system 200 of FIG. 2, for example. Many such computer-readable media are devised by those of ordinary skill in the art that are configured to operate in accordance with the techniques presented herein.

Although the subject matter has been described in language specific to structural features and/or methodological acts, it is to be understood that the subject matter defined in the appended claims is not necessarily limited to the specific features or acts described above. Rather, the specific features and acts described above are disclosed as example forms of implementing at least some of the claims.

As used in this application, the terms “component,” “module,” “system”, “interface”, and/or the like are generally intended to refer to a computer-related entity, either hardware, a combination of hardware and software, software, or software in execution. For example, a component may be, but is not limited to being, a process running on a processor, a processor, an object, an executable, a thread of execution, a program, and/or a computer. By way of illustration, both an application running on a controller and the controller can be a component. One or more components may reside within a process and/or thread of execution and a component may be localized on one computer and/or distributed between two or more computers.

Furthermore, the claimed subject matter may be implemented as a method, apparatus, or article of manufacture using standard programming and/or engineering techniques to produce software, firmware, hardware, or any combination thereof to control a computer to implement the disclosed subject matter. The term “article of manufacture” as used herein is intended to encompass a computer program accessible from any computer-readable device, carrier, or media. Of course, many modifications may be made to this configuration without departing from the scope or spirit of the claimed subject matter.

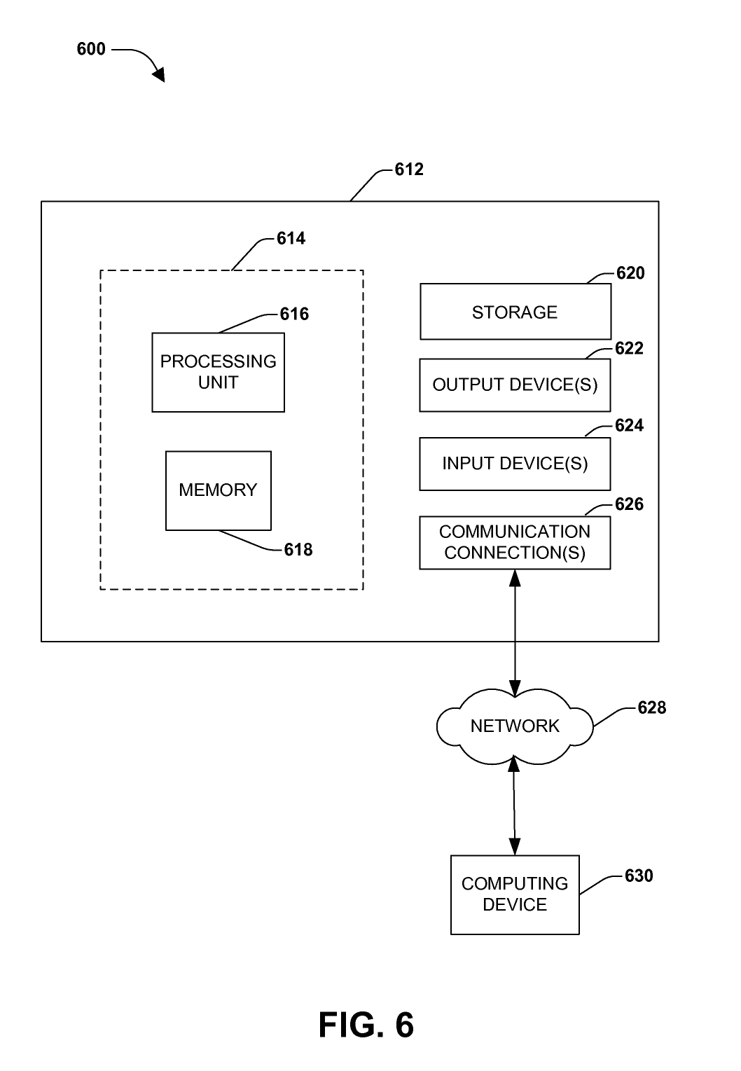

FIG. 6 and the following discussion provide a brief, general description of a suitable computing environment to implement embodiments of one or more of the provisions set forth herein. The operating environment of FIG. 6 is only one example of a suitable operating environment and is not intended to suggest any limitation as to the scope of use or functionality of the operating environment. Example computing devices include, but are not limited to, personal computers, server computers, hand-held or laptop devices, mobile devices (such as mobile phones, Personal Digital Assistants (PDAs), media players, and the like), multiprocessor systems, consumer electronics, mini computers, mainframe computers, distributed computing environments that include any of the above systems or devices, and the like.

Although not required, embodiments are described in the general context of “computer readable instructions” being executed by one or more computing devices. Computer readable instructions may be distributed via computer readable media (discussed below). Computer readable instructions may be implemented as program modules, such as functions, objects, Application Programming Interfaces (APIs), data structures, and the like, that perform particular tasks or implement particular abstract data types. Typically, the functionality of the computer readable instructions may be combined or distributed as desired in various environments.

FIG. 6 illustrates an example of a system 600 comprising a computing device 612 configured to implement one or more embodiments provided herein. In one configuration, computing device 612 includes at least one processing unit 616 and memory 618. Depending on the exact configuration and type of computing device, memory 618 may be volatile (such as RAM, for example), non-volatile (such as ROM, flash memory, etc., for example) or some combination of the two. This configuration is illustrated in FIG. 6 by dashed line 614.

In other embodiments, device 612 may include additional features and/or functionality. For example, device 612 may also include additional storage (e.g., removable and/or non-removable) including, but not limited to, magnetic storage, optical storage, and the like. Such additional storage is illustrated in FIG. 6 by storage 620. In one embodiment, computer readable instructions to implement one or more embodiments provided herein may be in storage 620. Storage 620 may also store other computer readable instructions to implement an operating system, an application program, and the like. Computer readable instructions may be loaded in memory 618 for execution by processing unit 616, for example.

The term “computer readable media” as used herein includes computer storage media. Computer storage media includes volatile and nonvolatile, removable and non-removable media implemented in any method or technology for storage of information such as computer readable instructions or other data. Memory 618 and storage 620 are examples of computer storage media. Computer storage media includes, but is not limited to, RAM, ROM, EEPROM, flash memory or other memory technology, CD-ROM, Digital Versatile Disks (DVDs) or other optical storage, magnetic cassettes, magnetic tape, magnetic disk storage or other magnetic storage devices, or any other medium which can be used to store the desired information and which can be accessed by device 612. Computer storage media does not, however, include propagated signals. Rather, computer storage media excludes propagated signals. Any such computer storage media may be part of device 612.

Device 612 may also include communication connection(s) 626 that allows device 612 to communicate with other devices. Communication connection(s) 626 may include, but is not limited to, a modem, a Network Interface Card (NIC), an integrated network interface, a radio frequency transmitter/receiver, an infrared port, a USB connection, or other interfaces for connecting computing device 612 to other computing devices. Communication connection(s) 626 may include a wired connection or a wireless connection. Communication connection(s) 626 may transmit and/or receive communication media.

The term “computer readable media” may include communication media. Communication media typically embodies computer readable instructions or other data in a “modulated data signal” such as a carrier wave or other transport mechanism and includes any information delivery media. The term “modulated data signal” may include a signal that has one or more of its characteristics set or changed in such a manner as to encode information in the signal.

Device 612 may include input device(s) 624 such as keyboard, mouse, pen, voice input device, touch input device, infrared cameras, video input devices, and/or any other input device. Output device(s) 622 such as one or more displays, speakers, printers, and/or any other output device may also be included in device 612. Input device(s) 624 and output device(s) 622 may be connected to device 612 via a wired connection, wireless connection, or any combination thereof. In one embodiment, an input device or an output device from another computing device may be used as input device(s) 624 or output device(s) 622 for computing device 612.

Components of computing device 612 may be connected by various interconnects, such as a bus. Such interconnects may include a Peripheral Component Interconnect (PCI), such as PCI Express, a Universal Serial Bus (USB), firewire (IEEE 1394), an optical bus structure, and the like. In another embodiment, components of computing device 612 may be interconnected by a network. For example, memory 618 may be comprised of multiple physical memory units located in different physical locations interconnected by a network.

Those skilled in the art will realize that storage devices utilized to store computer readable instructions may be distributed across a network. For example, a computing device 630 accessible via a network 628 may store computer readable instructions to implement one or more embodiments provided herein. Computing device 612 may access computing device 630 and download a part or all of the computer readable instructions for execution. Alternatively, computing device 612 may download pieces of the computer readable instructions, as needed, or some instructions may be executed at computing device 612 and some at computing device 630.

Various operations of embodiments are provided herein. In one embodiment, one or more of the operations described may constitute computer readable instructions stored on one or more computer readable media, which if executed by a computing device, will cause the computing device to perform the operations described. The order in which some or all of the operations are described should not be construed as to imply that these operations are necessarily order dependent. Alternative ordering will be appreciated by one skilled in the art having the benefit of this description. Further, it will be understood that not all operations are necessarily present in each embodiment provided herein. Also, it will be understood that not all operations are necessary in some embodiments.

Further, unless specified otherwise, “first,” “second,” and/or the like are not intended to imply a temporal aspect, a spatial aspect, an ordering, etc. Rather, such terms are merely used as identifiers, names, etc. for features, elements, items, etc. For example, a first object and a second object generally correspond to object A and object B or two different or two identical objects or the same object.

Moreover, “exemplary” is used herein to mean serving as an example, instance, illustration, etc., and not necessarily as advantageous. As used herein, “or” is intended to mean an inclusive “or” rather than an exclusive “or”. In addition, “a” and “an” as used in this application are generally be construed to mean “one or more” unless specified otherwise or clear from context to be directed to a singular form. Also, at least one of A and B and/or the like generally means A or B or both A and B. Furthermore, to the extent that “includes”, “having”, “has”, “with”, and/or variants thereof are used in either the detailed description or the claims, such terms are intended to be inclusive in a manner similar to the term “comprising”.

Also, although the disclosure has been shown and described with respect to one or more implementations, equivalent alterations and modifications will occur to others skilled in the art based upon a reading and understanding of this specification and the annexed drawings. The disclosure includes all such modifications and alterations and is limited only by the scope of the following claims. In particular regard to the various functions performed by the above described components (e.g., elements, resources, etc.), the terms used to describe such components are intended to correspond, unless otherwise indicated, to any component which performs the specified function of the described component (e.g., that is functionally equivalent), even though not structurally equivalent to the disclosed structure. In addition, while a particular feature of the disclosure may have been disclosed with respect to only one of several implementations, such feature may be combined with one or more other features of the other implementations as may be desired and advantageous for any given or particular application.

What is claimed is:

1. A method for ranking recommendations within a set of recommendations, comprising:
generating a set of locational relevance boundaries for ranking recommendations within a set of recommendations available to provide to a user, the set locational relevance boundaries comprising:
a baseline locational relevance boundary having a baseline rank influence, the baseline locational relevance boundary located a baseline threshold distance from a target recommendation location;
a static locational relevance boundary having a static rank influence, the static locational relevance boundary located within a static threshold distance from the target recommendation location;
an increasing locational relevance boundary having an increasing rank influence, the increasing locational relevance boundary corresponding to a first change in current location from the baseline threshold distance towards the static threshold distance; and
a decreasing locational relevance boundary having a decreasing rank influence, the decreasing locational relevance boundary corresponding to a second change in current location from the static threshold distance towards the baseline threshold distance; and
ranking the recommendations within the set of recommendations to create a ranked set of recommendations based upon the set of locational relevance boundaries and a current location of the user.

2. The method of claim 1, the ranking comprising:
responsive to determining that a first current location corresponds to the static locational relevance boundary, applying the static rank influence to a rank of a recommendation within the set of recommendations; and
responsive to determining that a second current location of the user corresponds to the decreasing locational relevance boundary, applying the decreasing rank influence to the rank of the recommendation.

3. The method of claim 1, the ranking comprising:
responsive to determining that a first current location of the user corresponds to the baseline locational relevance boundary, applying the baseline rank influence to a rank of a recommendation within the set of recommendations; and
responsive to determining that a second current location of the user corresponds to the increasing locational relevance boundary, applying the increasing rank influence to the rank of the recommendation.

4. The method of claim 1, the ranking comprising:
responsive to determining that a first current location of the user corresponds to the increasing locational relevance boundary, applying the increasing rank influence to a rank of a recommendation within the set of recommendations; and
responsive to determining that a second current location of the user corresponds to the static locational relevance boundary, applying the static rank influence to the rank of the recommendation.

5. The method of claim 1, the static rank influence greater than the baseline rank influence.

6. The method of claim 1, the ranking comprising at least one of:
applying the baseline rank influence to a rank of a recommendation within the set of recommendations such that the rank corresponds to a baseline rank;
applying the increasing rank influence to the rank to increase the rank;
applying the decreasing rank influence to the rank to decrease the rank; or
applying the static rank influence to the rank such that the rank corresponds to a static rank.

7. The method of claim 1, comprising:
configuring at least one of the baseline threshold distance or the static threshold distance based upon a user specified criterion.

8. The method of claim 1, comprising:
configuring at least one of the baseline threshold distance or the static threshold distance based upon at least one of a transportation mode, a time of day, weather, or a date.

9. The method of claim 1, comprising:
configuring at least one of the baseline threshold distance or the static threshold distance based upon a historical interaction pattern of the user.

10. The method of claim 1, comprising:
configuring at least one of the baseline threshold distance or the static threshold distance based upon a machine learned boundary.

11. The method of claim 1, comprising:
providing the ranked set of recommendations to the user during a recommendation session; and
during the recommendation session, modifying at least one of the baseline threshold distance or the static threshold distance.

12. The method of claim 1, comprising:
configuring at least one of the baseline threshold distance or the static threshold distance based upon a recommendation type of a recommendation within the set of recommendations.

13. The method of claim 1, the generating comprising:
generating a user configured locational relevance boundary having a user configured rank influence, the user configured locational relevance boundary corresponding to one or more threshold distances from the target recommendation location.

14. The method of claim 1, the generating comprising:
generating a hidden locational relevance boundary having a hidden rank influence, the hidden locational relevance boundary corresponding to a hidden threshold distance from the target recommendation location.

15. The method of claim 1, comprising:
providing the ranked set of recommendations to the user during a recommendation session;
re-ranking the ranked set of recommendations during the recommendation session to create a re-ranked set of recommendations based upon an updated current location of the user; and
providing the re-ranked set of recommendations to the user during the recommendation session.

16. The method of claim 1, the generating comprising:
generating a locational relevance boundary based upon at least one of a linear function, a Gaussian function, a step function, a logarithmic function, or a non-linear function.

17. The method of claim 1, comprising:
providing a recommendation within the ranked set of recommendations to the user based upon a rank of the recommendation exceeding a rank threshold; and
responsive to determining that the current location of the user corresponds to the target recommendation location:
hiding the recommendation based upon the recommendation having a first recommendation type; and
populating the recommendation with additional information based upon the recommendation having a second recommendation type.

18. A system for ranking recommendations within a set of recommendations, comprising:
a recommendation ranking component configured to:
generate a set of locational relevance boundaries for ranking recommendations within a set of recommendations available to provide to a user, the set locational relevance boundaries comprising:
a static locational relevance boundary having a static rank influence, the static locational relevance boundary located within a static threshold distance from a target recommendation location;
an increasing locational relevance boundary having an increasing rank influence, the increasing locational relevance boundary corresponding to a first change in current location from a baseline threshold distance towards the static threshold distance; and
a decreasing locational relevance boundary having a decreasing rank influence, the decreasing locational relevance boundary corresponding to a second change in current location from the static threshold distance towards the baseline threshold distance; and
rank the recommendations within the set of recommendations to create a ranked set of recommendations based upon the set of locational relevance boundaries and a current location of the user.

19. The system of claim 18, the set of locational relevance boundaries comprising:
a baseline locational relevance boundary having a baseline rank influence, the baseline locational relevance boundary located the baseline threshold distance from the target recommendation location.

20. A computer readable medium comprising instructions which when executed perform a method for ranking recommendations within a set of recommendations, comprising:
ranking recommendations within a set of recommendations based upon a set of locational relevance boundaries comprising at least one of a baseline locational relevance boundary having a baseline rank influence, a static locational relevance boundary having a static rank influence, an increasing locational relevance boundary having an increasing rank influence, or a decreasing locational relevance boundary having a decreasing rank influence, the ranking comprising:
responsive to determining that a first current location of a user corresponds to the static locational relevance boundary, applying the static rank influence to a rank of a recommendation within the set of recommendations; and
responsive to determining that a second current location of the user corresponds to the decreasing locational relevance boundary, applying the decreasing rank influence to the rank of the recommendation.
